(19) United States
(12) Patent Application Publication
(10) Pub. No.: US 2014/0030705 A1
(43) Pub. Date: Jan. 30, 2014

(54) SYSTEMS AND METHODS FOR ASSESSING BIOMOLECULE CHARACTERISTICS

(71) Applicants: Parikshit A. Deshpande, Princeton, NJ (US); Arthur G. Marlin, Willow Grove, PA (US); Michael Kochersperger, Princeton, NJ (US); Alexey Sharonov, Bethany, CT (US)

(72) Inventors: Parikshit A. Deshpande, Princeton, NJ (US); Arthur G. Marlin, Willow Grove, PA (US); Michael Kochersperger, Princeton, NJ (US); Alexey Sharonov, Bethany, CT (US)

(73) Assignee: BioNano Genomics, Inc., San Diego, CA (US)

(21) Appl. No.: 13/880,365

(22) PCT Filed: Oct. 20, 2011
(86) PCT No.: PCT/US11/57115

§ 371 Date: Oct. 7, 2013

Related U.S. Application Data
(60) Provisional application No. 61/394,915, filed on Oct. 20, 2010.
(60) Provisional application No. 61/407,182, filed on Oct. 27, 2010.
(60) Provisional application No. 61/407,302, filed on Oct. 27, 2010.
(60) Provisional application No. 61/418,516, filed on Dec. 1, 2010.

(51) Int. Cl. G01N 21/64

(52) U.S. Cl. CPC G01N 21/6486
USPC 435/6.1; 435/288.7

(57) ABSTRACT

Provided are methods and systems for assessing the presence and extent of damage on a polynucleotide. The methods include incorporating a label at the site of the damage and imaging the label to determine the presence and extent of the damage. The systems include devices capable of performing damage assessment on single molecules.

### RELATED APPLICATIONS

The present application claims priority to U.S. Application 61/407,302, “Nanoanalyzer Systems and Methods,” filed on Oct. 27, 2010; U.S. Application 61/394,915, “DNA Damage Detection in Nanochannel Array,” filed on Oct. 20, 2010; U.S. Application 61/407,182, “Single Molecule DNA Nanochannel Analysis for Genomic Studies,” filed on Oct. 27, 2010; and U.S. Application 61/418,516, “DNA Damage Detection in Nanochannel Array,” filed on Dec. 1, 2010. These applications are incorporated herein in their entireties for any and all purposes.

### GOVERNMENT RIGHTS

This work was supported by National Institutes of Health grant 2R44H004199-03-NIH/NHGRI; by National Institute of Standards and Technology grant 70NANB7H7O27N NIST-ATP 2007; and by National Institutes of Health grant 1R43HG004817-01 NIH/DHHS. The government has certain rights in this disclosure.

### TECHNICAL FIELD

The present disclosure relates to the field of nucleic acid analysis, to the field of nanofluidics, and to the field of optical instrumentation.

### BACKGROUND

The genomes of living organisms are constantly at risk for endogenous and environmentally induced DNA alterations. DNA lesions at specific genomic sites can lead to changes in nucleotide sequence. DNA molecules can be damaged in numerous ways, including (a) mismatches arising during DNA replication; (b) damage resulting from instability of DNA molecules, such as incorporation of uracil, deamination of bases, depurination and depyrimidination; (c) damage due to environmental factors. For example, ionizing radiation produces modified bases and strand breaks, and UV radiation produces cyclobutane pyrimidine dimers and other photoproducts. Exemplary DNA damage scenarios are illustrated in FIG. 1.

The consequences of DNA damage result in DNA fragmentation (double strand DNA breaks), single stranded DNA breaks and modified bases. Currently, there is limited available high-throughput and sensitive methods to detect these events without the need of DNA amplification, which amplification could conceal those modifications. Accordingly, there is a need in the art for methods and systems for detection of polynucleotide damage.

### SUMMARY

In meeting the described challenges, the present disclosure first provides methods, the methods including converting a first site on a polynucleotide to a first moiety capable of supporting polymerase extension; effecting extension at the first moiety so as to incorporate a first label at or proximate to the first site; linearizing a portion of the polynucleotide that includes the first label; and imaging the first label.

The disclosure also provides analysis systems, the systems suitably including a sample stage configured to receive a fluidic chip that comprises one or more nanochannels having a characteristic dimension in the range of from 1 nm to about 250 nm, an illumination source configured to illuminate a sample disposed within the fluidic chip; and an image collector configured to collect an image of an illuminated sample disposed within the fluidic chip.

Also provided are methods, the methods including contacting a first single-strand break in a polynucleotide with an alkaline phosphatase so as to give rise to a first moiety capable of supporting polymerase extension; contacting the moiety with a polymerase and a labeled nucleotide so as to incorporate a label into the polyoligonucleotide; linearizing at least a portion of the polynucleotide by confining the first label within a nanochannel; and imaging the first label.

Additionally provided are methods, the methods including applying to a single-strand break in a polynucleotide a DNA polymerase having 3′ to 5′ exonuclease activity so as to convert the non-extendable single strand break into a polymerase-extendable sites; and applying a DNA polymerase and a labeled deoxynucleotide so as to incorporate a label into the polynucleotide.

The disclosure also provides methods, the methods including disposing a polynucleotide having an abasic site within a porous matrix material; contacting the polynucleotide with an alkaline material so as to covert the abasic site to a single strand break in the polynucleotide, so as to convert a single strand break in the polynucleotide to a double strand break in the polynucleotide, or both; converting a single strand break in the polynucleotide, a double strand break in the polynucleotide, or both, to a moiety capable of supporting polymerase extension; and contacting the moiety with a polymerase and a labeled nucleotide so as to incorporate one or more labels into the polynucleotide.

Further disclosed are additional methods, these methods including disposing a polynucleotide within a porous matrix material; converting a first site on a polynucleotide to a first moiety capable of supporting polymerase extension; effecting extension at the first moiety so as to incorporate a first label at or proximate to the first site; linearizing at least a portion of the polynucleotide by confining the first label within a nanochannel; and imaging the first label.

Further disclosed are kits, the kits including a quantity of an N-glysosylase; a quantity of an apurinic/apyrimidinic lysase, a 3′-phosphodiesterase, or both; a quantity of a polymerase; and a quantity of a labeled nucleotide.

Kits may also include a quantity of an alkaline material; a quantity of an apurinic/apyrimidinic lysase, a 3′-phosphodiesterase, or both; a quantity of a polymerase; and a quantity of a labeled nucleotide.

Also provided are systems. These systems suitably include a kit that includes (a) a quantity of a polymerase, (b) a quantity of a labeled nucleotide, and (c) a quantity of one or more of an apurinic/apyrimidinic lysase, a 3′-phosphodiesterase, or Endonuclease IV, the kit being adapted to engage with a sample imager, the sample imager comprising a sample stage adapted to engage with a fluidic chip that includes one or more nanochannels, an illumination source capable of optical communication with a sample disposed within a nanochannel of the fluidic chip, an image collector capable of collecting an image of an illuminated sample disposed within the nanochannel.

Other methods provided herein include linearizing a region of a polynucleotide that includes at least one label, the label having been incorporated into the polynucleotide by polymerase extension, the polymerase extension being performed on a moiety that was converted from an abasic site, a single strand break, or both.

Additional methods disclosed herein include incorporating a label at or proximate to a site of damage on a polynucleotide; linearizing a region of the polynucleotide that includes the label; and imaging the label.

The present disclosure also provides systems, the systems including a base configured to receive a fluidic chip; an illuminator configured to illuminate a polynucleotide sample disposed within the fluidic chip; and an image collector configured to collect an image from the polynucleotide sample disposed within the fluidic chip.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1 illustrates exemplary DNA lesions that may result from DNA damage, which lesions include single strand breaks (SSBs), double strand breaks (DSBs), and modified bases;

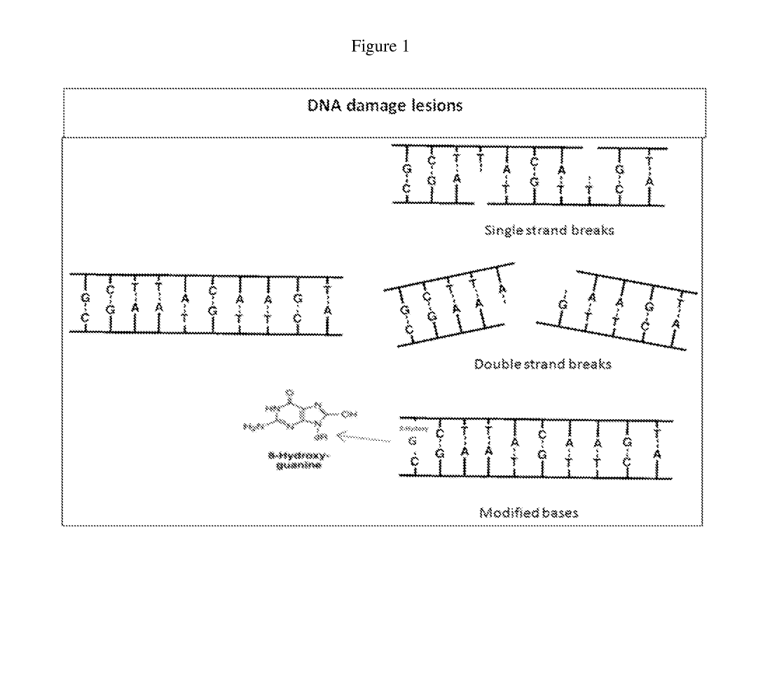

Table 1 illustrates an example of the types and quantities of DNA lesions resulting from exposure of DNA to ionizing radiation in the form of gamma rays generated from Cesium 137 (¹³⁷Cs);

FIG. 2 illustrates an illustrate process according to the present disclosure using N-glycosylases to recognize ultraviolet (UV)-damaged bases and also oxidative damaged bases, followed by fluorescent labeling of the DNA damage sites;

FIG. 3 illustrates exemplary size distributions of human genomic DNA purified from three different DNA purification protocols: Ss1: Buccal Gentra Pure Gene kit (Qiagen); S2: Cell Gentra Pure Gene kit (Qiagen); S3: Easy DNA kit (Invitrogen). The relative size distributions were assayed using pulsed field gel electrophoresis (PFGE, left-hand panel of figure) while a size histogram was generated for the same DNA samples flowed through and imaged in a nanochannel array (middle panel of figure), quantification of DNA mass greater than 100 Kbp in length as a ratio to DNA mass less than 100 Kbp is provided in the right-hand panel;

FIG. 4 (top panel) illustrates the size histograms for fosmid DNA subjected to UV damage and subsequently subjected to DNA repair enzymes EndonucleaselV and T4 EndonucleaseV in conjunction with Vent(exo-) polymerase and fluorescent nucleotides, and the bottom panel illustrates an exemplary single strand nicking density of fosmid DNA as a function of UVC exposure, where UVC exposure ranged from 0-5,000 J/m²;

FIG. 5 presents exemplary size histograms for fosmid DNA subjected to UV damage and then contacted with to DNA repair enzymes Endonuclease IV and UVDE, with Vent(exo-) polymerase and fluorescent nucleotides;

FIG. 6 presents exemplary size histograms for fosmid DNA subjected to hydrogen peroxide (H₂O₂) damage and subsequently subjected to DNA repair enzymes Endonuclease IV and Endonuclease III along with Vent(exo-) polymerase and fluorescently-labeled nucleotides, the H₂O₂ treatment of fosmid DNA ranged from 0-2.5 μM;

FIG. 7 presents an alternative DNA damage assessment assay that includes disposing cells in a porous matrix;

FIG. 8 presents data from triplicate human cell samples subjected to 0 μM vs. 500 μM hydrogen peroxide and processed using the alternative cell-based DNA damage assay presented in FIG. 7. FIG. 8A illustrates size histograms of human genomic DNA following hydrogen peroxide (H₂O₂) treatment of human B cells. The cells were embedded in agarose and lysed, followed by alkaline treatment before being subjected to the DNA repair enzyme Endonuclease IV in conjunction with Vent(exo-) polymerase and fluorescent nucleotides before β-agarase digestion of the cell plugs, FIG. 8B illustrates the average molecule length and average label density (labels/100 kb);

FIG. 9 illustrates a single molecule imaging of fluorescently-labeled DNA within a nanochannel array (A) and subsequent data analysis (B), which demonstrate increased labeling density in a dose-dependent manner and reduced molecular size for human genomic DNA treated with UVC radiation. The UVC-treated samples analyzed in the nanochannel array were also run on a pulsed field gel electrophoresis (PFGE) gel (C) for molecular sizing comparison, as shown in the figure;

FIG. 10 depicts a processing path for detecting oxidative damage to DNA;

FIG. 11 illustrates an exemplary mapping of data from DNA processed according to the present disclosure;

FIG. 12 presents a comparison between existing illumination systems and illumination systems used in the present disclosure;

FIG. 13 depicts a schematic of an autofocus system used in the disclosed systems;

FIG. 14 illustrates external and internal views of a system according to the present disclosure;

FIG. 15 illustrates an internal view of a system according to the present disclosure;

FIG. 16 illustrates an internal view of a system according to the present disclosure; and

FIG. 17 presents an illustrative imaging workflow according to the present disclosure.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range. Any and all documents cited in this application are incorporated herein by reference in their entireties.

In a first aspect, the present disclosure provides methods. These methods may be used, for example, to assess the presence, type, and extent of damage that may be present on a polynucleotide.

The methods suitably include converting a first site on a polynucleotide to a first moiety capable of supporting polymerase extension; effecting extension at the first moiety so as to incorporate a first label at or proximate to the first site; linearizing a portion of the polynucleotide that includes the first label; and imaging the first label.

Linearizing may be effected in a number of ways. In one embodiment, the linearizing is effected by confining, within a nanochannel, a portion of the polynucleotide that includes the first label. Suitable nanochannels are described in U.S. patent application Ser. No. 10/484,293, now granted and incorporated herein by reference in its entirety. A nanochannel used to linearize a polyoligonucleotide suitably has a trench width of less than about 250 nm, less than about 200 nm, less than about 150 nm, less than about 100 nm, or even less than about 50 nm. The nanochannel may have a trench depth of less than about 200 nm, less than about 150 nm, less than about 100 nm, or even about 2 nm. The nanochannel suitably has a characteristic dimension (depth, width, length) in the range of from 1 nm to about 250 nm. U.S. patent application Ser. No. 10/484,293 describes various ways of fabricating such nanochannels and nanochannel arrays.

The nanochannels may themselves be enclosed, either in whole or in part, and may also be of uniform or of varying depth, as described in U.S. patent application Ser. No. 11/536,178, the entirety of which is incorporated herein by reference. The nanochannels may also include posts, pillars, or other obstacles so as to modulate the passage of polynucleotides transported within the nanochannels, as described in U.S. patent application Ser. No. 11/536,178. The nanochannel may be of sufficient length to contain at least a portion of the polynucleotide, and the labeled portion of the polynucleotide is suitably within the region being elongated.

The first site of the polynucleotide is suitably a damaged site, and may be a single-strand break in the polynucleotide, or even a double-strand break in the polynucleotide. First sites suitable for the disclosed methods also include cyclobutane-pyrimidine dimers, photoproducts (e.g., 6-4 photoproducts), thymine dimers, oxidized pyrimidines, abasic sites (e.g., apurinic sites, apyrimidinic sites). Valence isomers of the foregoing and Dewar valence isomers of the foregoing are also suitable, as are combinations of any of these sites.

Conversion of the first site suitably gives rise to an apyrimidic site, an apurinic site, a single-strand break (suitably non-extendible), or some combination of these. The converting may be effected by contacting the first site with an enzyme that hydrolyzes an apurinic site, hydrolyzes an apyrimidinic site, or both. The contacting may be accomplished by contacting the first site with an N-glycosylase, an alkaline material, or even with both.

A variety of compounds may be used as N-glycosylases, including Endonuclease III, T4 Endonuclease V, Endonuclease VIII, ultraviolet DNA endonuclease, formamidopyrimidine DNA glycosylase, and the like. Combinations of compounds may be used to effect conversion.

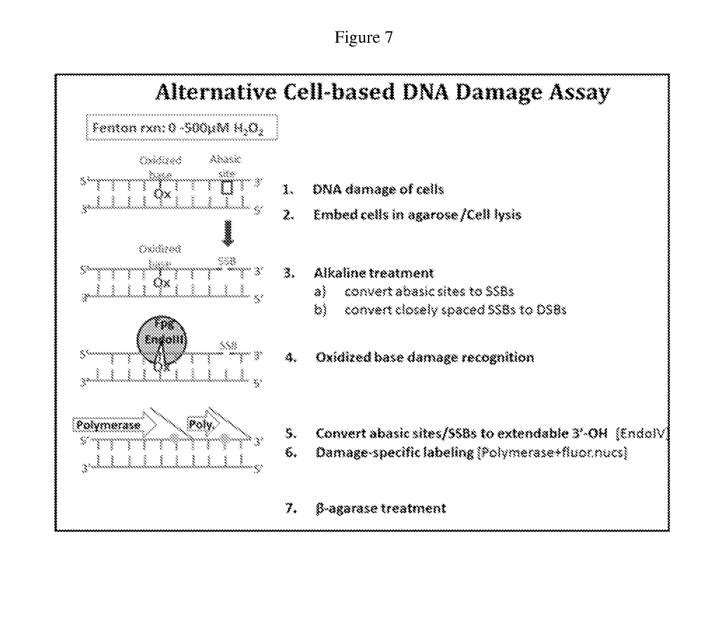

In one embodiment, the first site may be an abasic site, which abasic site is contacted with an alkaline material. A variety of alkaline materials (e.g., a basic solution) may be used. The alkaline material then suitably converts the abasic site to a single-strand break. This aspect of the disclosed methods is illustrated in FIG. 7, which figure illustrates the conversion of an abasic site to a single strand break (“SSB”) by application of an alkaline treatment. An alkaline treatment may also be used to convert a single strand break to a double strand break, which conversion is effected by contacting the single strand break with the alkaline solution so as to effect conversion to a double strand break.

A user may further contact an abasic (apyrimidic/apurinic) site, or a single-strand break (suitably non-extendible), or both with an apurinic/apyrimidinic lysase, a phosphodiesterase, or any combination thereof. Endonuclease IV is considered an especially suitable lysase for this purpose, although other so-called AP lysases including (but not limited to) AP endonuclease class I, endodeoxyribonuclease (apurinic or apyrimidinic), deoxyribonuclease (apurinic or apyrimidinic), E. coli endonuclease III, phage-T4 UV endonuclease, Micrococcus luteus UV endonuclease, AP site-DNA 5′-phosphomonoester-lyase, and X-ray endonuclease III, may also be used.

As described, a feature of the polynucleotide may labeled by conversion of the feature into a site capable of label incorporation. In such embodiments, this may be accomplished by using a N-glycosylase to convert a base into a chemical configurations capable of label incorporation. This conversion may be effected by incubating a N-glycosylase with a polynucleotide. This in turn results in conversion of damaged DNA base into an abasic (i.e., apurinic/apyrimidinic) site. This conversion may occur by cleavage of a N-glycosyl bond between a nucleotide sugar and base. An abasic endonuclease may then be applied to convert the abasic site into a polymerase-extendable site. Subsequent application of a DNA polymerase and a fluorescent deoxynucleotide then results in incorporation of a fluorescent label at the site of DNA damage.

A user may label oxidized purine damage. This may be accomplished by application of FPG (formamidopyrimidine [fapy]-DNA glycosylase) so as to convert an oxidized purine into an abasic site. The user may then apply an abasic (i.e., apurinic/apyrimidic) endonuclease or other abasic endonuclease to convert the abasic site into a polymerase-extendable site. The user may then apply DNA polymerase and a fluorescent nucleotide (or deoxynucleotide), which in turn fluorescently labels the site of original DNA oxidative damage.

Oxidized pyrimidine damage may also be labeled. This is suitably accomplished by application of Endonuclease III, Endonuclease VIII, or both so as to convert oxidized pyrimidine into an abasic site. The user may then apply an abasic (i.e., apurinic/apyrimidic) endonuclease so as to convert an abasic site into a polymerase-extendable site. The site may then be labeled by application of DNA polymerase with a fluorescent deoxynucleotide.

Single strand breaks and abasic sites may also be labeled. This is accomplished by using an abasic endonuclease to non-extendable single strand breaks and abasic sites into polymerase-extendable sites. The user may then apply DNA polymerase and fluorescent (or otherwise labeled) deoxynucleotides to label the polymerase-extendable site.

Extension of the polynucleotide is suitably accomplished by contacting the polynucleotide with a polymerase and a nucleotide (including a deoxynucleotide) that includes the first label. A label may be a fluorophore, a radioactive particle, and the like. This labeling may be accomplished by binding a fluorescent probe to a section or feature of the oligonucleotide. The probe may include a portion that is complimentary to a portion of the oligonucleotide, and the user may act to expose the complimentary portion of the oligonucleotide. The label need not necessarily be attached directly to the nucleotide, as the nucleotide may itself include a moiety that then binds to the label or to some other, complementary moiety that is bound to the fluorophore.

The first moiety is suitably one that is capable of supporting polymerase extension, such as a 3′-OH structure. In this way, the user may apply the polymerase and labeled nucleotide or nucleotides so as to incorporate the label or labels at or nearby to the site of the first moiety (and, by extension, at or nearby to the first site, which site in turn corresponds to the location of the polynucleotide damage or lesion). The label may be at the site of the damage, or be within 1, 5, 10, 15, 20, 50, or even 100 bases from the site of the damage.

The user may then, as described herein, linearize a portion of the polynucleotide that includes the label and image or otherwise visualize the label. This may be accomplished by linearizing the polynucleotide within a nanochannel, as described elsewhere herein. The linearizing may also be accomplished by affixing a portion (e.g., an end) of the polynucleotide to a substrate and then elongating a portion of the polynucleotide by application of a gradient force (e.g., an electrical gradient), or even by allowing a fluid in which the polynucleotide is suspended to evaporate so as to elongate the polynucleotide by action of the advancing air/fluid front of the drop.

The labeled, elongated polynucleotide is suitably imaged in linearized form, e.g., within a nanochannel. This imaging enables the user to locate any labels disposed on the polynucleotide. Imaging also enables the user to determine whether a particular label is or is not present on the polyoligonucleotide. For example, the user may introduce a probe that fluoresces at a wavelength at 560 nm to the polyoligonucleotide, where the probe is complimentary to a specific base sequence. If the probe is not detected at the imaging step, the user will then understand that the specific capture sequence for the probe was not present on the polyoligonucleotide.

The user may suitably characterize at least one structural feature of the polynucleotide, such as locating the position of at least one label on the polynucleotide, determining the relative positions of two or more labels on the polynucleotide, calculating the number of labels in a length of the polynucleotide, or even determining the number of labels present in a sample that contains the polynucleotide.

The user may also correlate the presence or location of the first label to a structural characteristic of the polynucleotide, or even correlating the presence or location of two or more labels to a structural characteristic of the polynucleotide. As one example, the user may process a polynucleotide according to the disclosed methods. Detecting the presence of a label indicates to the user that the polynucleotide under examination contains some damage. Locating the label within the larger context of the polynucleotide will indicate to the user that the damage has occurred at a particular location within the polynucleotide. For example, the user may determine that a label resides within a region of the polynucleotide that corresponds to a particular gene, which in turn suggests that the subject's ability to express that particular gene may be impaired or altered.

The user may also determine that the presence of multiple labels is suggestive of damage at multiple locations. A user may use different labels (e.g., first and second fluorophores, which molecules in turn differ from one another in terms of structure or even in terms of their excitation and/or emission wavelengths). In this way, the user may apply different labels to different locations (e.g., via successive rounds of polymerase/nucleotide application) and then assay the polynucleotide for the presence of these labels. In this way, the user may determine that there is damage at multiple sites on a polynucleotide.

A user may construct a data set based on the imaged polyoligonucleotide within the nanochannel so as to analyze each labeled feature comprising the polynucleotide to obtain a set of observed data values. This information may include information regarding presence of labels, the spacing between labels, the sequence of labels on the polyoligonucleotide, and the like. The user can then characterize the polynucleotide based on this set of observed data values. As one example, the user may determine that the spacing between labels that are a certain distance apart in a “normal” individual suggests that the individual possesses a mutation in their gene between the locations for those two labels. The user may also determine that the presence of particular labels (as opposed to the labels' absence) indicates the presence of mutation.

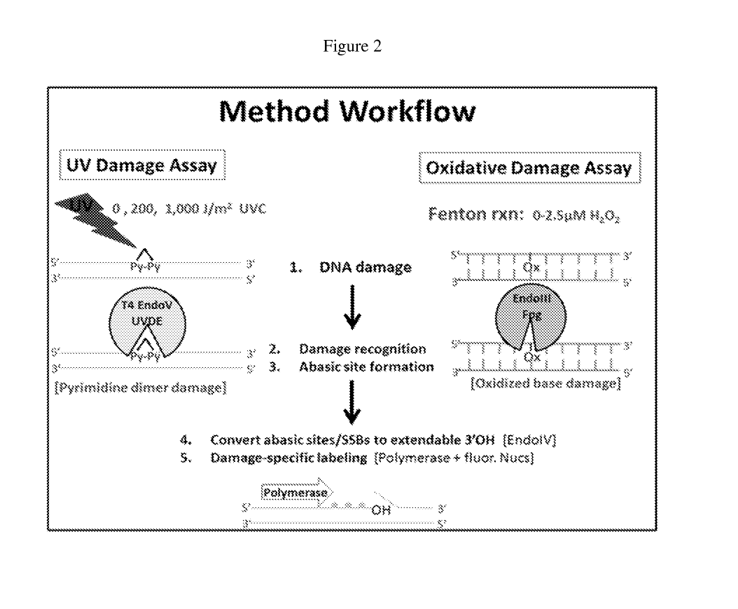

Different labels may be used to indicate the presence of different kinds of damage. For example, as shown in FIG. 2, a user may test a polynucleotide for the presence of UV- and oxidative-caused damage. The user may incorporate a first label during processing of UV-damaged sites and a second label (that differs in excitation and/or emission characteristics from the first label) during processing of oxidation-damaged sites. By assaying for the presence of both labels, the user may determine the presence and location of UV- and oxidation-damaged sites on the polynucleotide.

In some embodiments, at least part of the methods (e.g., conversion of the first site, creation of the moiety used to support extension) are performed while the polynucleotides reside within a porous matrix, such as agarose or polyacrylamide. For example, the polynucleotide may reside in cells that are themselves disposed within the porous matrix. The cells may be lysed, and the polynucleotides—still residing within the matrix—may be processed according to the disclosed methods. Alternatively, the polynucleotides may be recovered (e.g., by lysing) from cells and then disposed within the porous matrix. By processing the polynucleotides within the porous matrix, a user may avoid the fluid handling steps that are associated with amplification and other processes, which fluid handling may introduce shear forces that can damage the polynucleotides being analyzed. A user may digest (using a restriction enzyme) a polynucleotide as part of the disclosed methods.

In embodiments where the user employs a matrix, the user may affix at least part of the polynucleotide to the matrix, though this is not a requirement. This may be effected by a biotin-avidin pairing, by a receptor-ligand reaction, by an antibody-antigen reaction, and the like.

Imaging the label may be effected by illuminating the label. In the case of a fluorophore label, the user may image the label by illuminating the label with illumination having the fluorophore's excitation wavelength and then collecting illumination reflected from the label with an image collector, such as a CCD or CMOS device.

The present disclosure also provides systems. These systems suitably include a sample stage configured to receive a fluidic chip that comprises one or more nanochannels having a characteristic dimension in the range of from 1 nm to about 250 nm, an illumination source configured to illuminate a sample disposed within the fluidic chip; and an image collector configured to collect an image of an illuminated sample disposed within the fluidic chip.

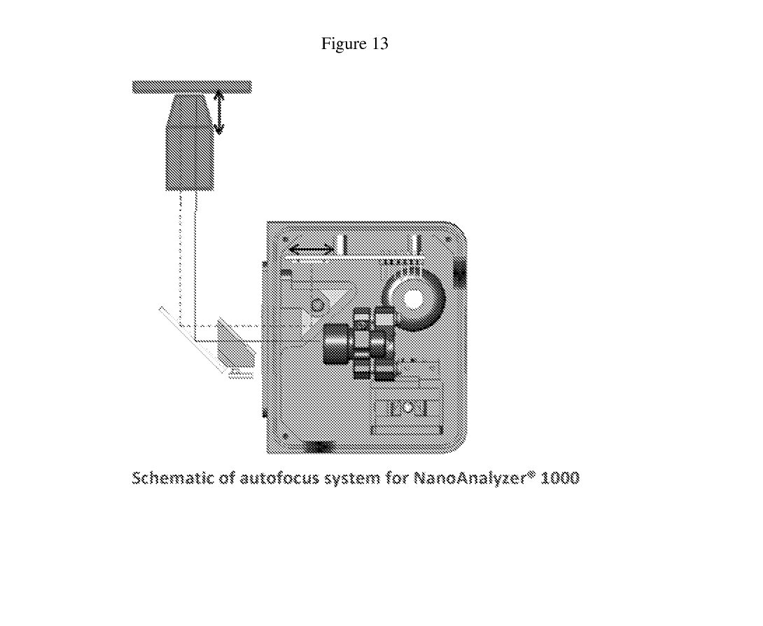

In some embodiments, the system includes a detector capable of detecting a first beam of illumination reflected from a sample disposed within the fluidic chip. Such detectors may be CCD cameras, focal plane arrays, CMOS devices, photodiodes, photodiode arrays, position sensing devices, EMCCDs, CCDs, PMTs, avalanche photodiodes, and the like. One exemplary arrangement is shown in FIG. 13, which figure illustrates an exemplary autofocus system in which illumination is delivered from an illumination source to the sample, reflected back from the sample, and collected by an image collector. The position of the sample may in turn be adjusted in response to the position of the reflected illumination on the image collector. An exemplary system is described in patent application PCT/US2010/035253, “Devices And Methods For Dynamic Determination Of Sample Spatial Orientation And Dynamic Repositioning,” filed May 18, 2010, the entirety of which is incorporated herein by reference in its entirety. The system may include detector capable of detecting the positions of first and second beams of illumination reflected from a sample disposed within the fluidic chip; in such embodiments, the system applies two or more beams of illumination to the sample.

The position of the stage or fluidic chip may be modulated by a controller that is configured to translate the stage in response to a position of the first beam of illumination reflected from the sample disposed within the fluidic chip. As described above, the chip may be translated in response to the location of illumination reflected from the sample to the image collector. The controller may use as an input the distance between first and second positions of at least one of the first or second beams of illumination reflected from the sample disposed within the fluidic chip.

Systems according to the present disclosure may include one or more optical filters. Such filters may be present in a filter wheel or other device capable of changing the filter that is in place. The filter or filters are suitably disposed within the illumination path between the source of illumination and the sample such that the filter may be used to alter the wavelength of illumination provided to the sample disposed within the fluidic chip, or, alternatively, to filter illumination reflected from the sample.

Systems may include one, two, or even more sources of illumination. The illumination sources may be lasers, LEDs, incandescent bulbs, ultraviolet sources, and the like. A system may include two (or more) sources of illumination that are configured to provide illumination of different wavelengths. By using such different sources of illumination, or by using illumination filters, a user may apply illumination of multiple wavelengths to a sample, which in turn provides the ability to excite labels having different excitation wavelengths.

Systems may also include a beam expander disposed in an illumination path between the illumination source and the sample. Keplerian beam expanders, Galilean beam expanders, and the like are all suitable for this purpose. Suitable optical components may be purchased from, e.g., Thorlabs (www.thorlabs.com) and Newport (www.newport.com). The beam expander acts to spread excitation light over the entire field of view. Expansion of the beam provides uniform illumination which allows for uniform excitation of the fluorophores in the field of view.

The system may include a source of electric or other (e.g., pressure) field that is configured to motivate a fluid sample into or within a nanochannel of the fluidic chip. Such a field may be a static field or a varying field. The system may be configured to apply the field at the request of the user or automatically such that the system applies the field when a fluidic chip is placed into the system.

Fluid chips may include one or more indicia disposed thereon. Such indicia may be barcodes, images, alphanumeric text, and the like. The chip may also include indicia that are themselves a shape of the chip—for example, the index of a chip may be a curve, peg, slot, or other protrusion formed in or on the chip. The system may include a reader or other device that is adapted to configure the system in accordance with one or more indicia disposed on a fluidic chip. For example, a chip may include a particular index or indicia that indicate that the chip contains a sample that is to be assessed for the presence of UV damage or a sample that has already been processed to assess UV damage. The system may in turn self-configure in response to indicia on the chip so as to, for example, apply illumination of the wavelengths that correspond to the excitation wavelengths of fluorophore labels incorporated into the polynucleotide sample during earlier processing.

The disclosed systems may include various elements. Descriptions of exemplary embodiments of these elements are provided

Multiple Illumination Sources

The systems may include multiple illumination (e.g., laser) sources of differing wavelengths. Each source may in turn fluorescently excite fluorescent dyes with differing spectral characteristics. Lasers may be of the same or different types, including diode pumped solid state lasers and diode lasers. Typical wavelengths span the range the UV to infrared. Non-laser sources such as lamps and LEDs can also be used as excitation sources for fluorescent imaging. Multiple wavelengths can be used to illuminate labels or tags that fluoresce or are otherwise visible at different wavelengths from one another. For example, application of radiation at 300 nm and 500 nm will enable the user to locate probes (if any) that fluoresce at one of those wavelengths. In this way, the user can apply different wavelengths to a sample to quickly determine whether a particular probe (e.g., a probe attached to an adenoside base) is present or not present on the sample or even at a particular location. By attaching different probes to different bases, the user can then illuminate the sample appropriately to determine the location (or absence) of particular bases that the user has sought to incorporate into a sample.

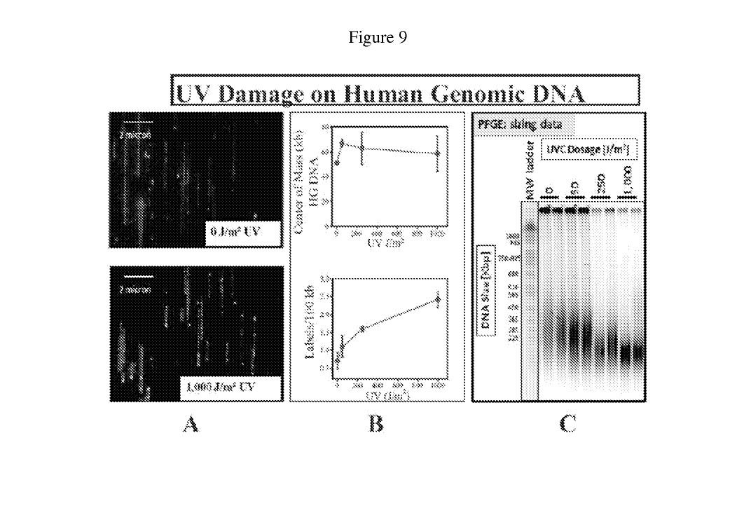

FIG. 9 shows single molecule imaging of fluorescently-labeled DNA within a nanochannel array (A) and subsequent data analysis (B). These demonstrate an increased labeling density in a dose-dependent manner and a reduced molecular size for human genomic DNA that was irradiated with UVC radiation. The UVC-treated samples analyzed in the nanochannel array were also run on a pulsed field gel electrophoresis (PFGE) gel (panel C) for molecular sizing comparison, as shown in the figure, which figure shows dose-dependent sizing data.

Beam Shaping and High Magnification

To achieve illumination of a broad area of the nanochannel array, the systems may also include beam expansion optics to expand the diameter of the laser beam and more uniformly illuminate the field of view. Both Keplerian and Galilean beam expanders can be employed. Typical expansion factors range from 1× to 30×. As needed, beam scanning optics can be implemented for applications requiring high laser intensity. Beam scanning may be performed by scanning mirrors, micromirrors or other beam deflection systems known to those of ordinary skill in the are.

Wide Field Epi-Illumination

Another feature of some embodiments of the disclosed systems is the use of wide field epi-illumination to consistently image fluorescent single molecules. In many single molecule imaging applications, a total internal reflection (TIRF) scheme is used for imaging. In such a scheme, incident excitation light strikes the imaging plane at an angle that permits only a small fraction of the light to penetrate into the sample area.

A consequence of the TIRF approach is that material (typically liquid, but not in all cases) that is distal to the imaging plane (more than 100 nm away) is not excited and will therefore not contribute any background signal.

TIRF systems are complex and difficult to align correctly. By contrast, an epi-illumination system does not rely on the incidence angle of the excitation light and is consequently easier to align and is more stable. The disclosed systems make use of this approach because of the unique nature of the nanochannel array. The nanochannel array confines molecules and reagents to depths of 100 nm or less, which obviates the need for TIRF illumination. In conjunction with the autofocus system, the system has a stable optical system capable of reliably delivering high speed single molecule detection without the need for complex or bulky vibration dampening. This is a key advantage of using epi-illumination when performing single molecule detection and is enabled by the nanochannel array technology. The epi-illumination system enables a user to illuminate and detect from the same side of the sample, which acts to reduce the amount of excitation light that enters the detector.

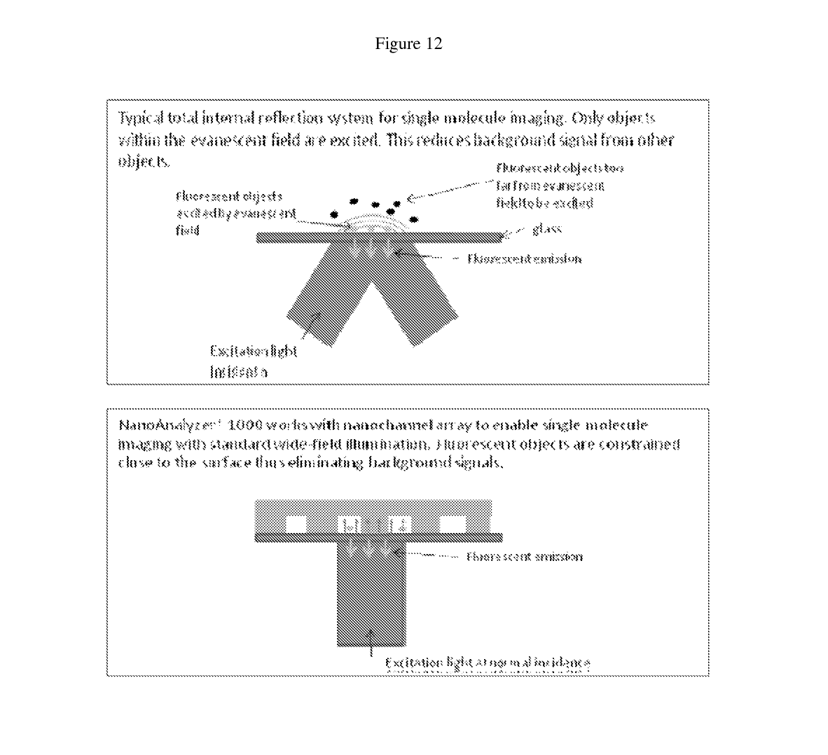

An exemplary illumination scheme is illustrated in FIG. 12. As shown in the upper panel of that figure, in a TIRF system, only objects within the evanescent field are excited. This in turn reduces the background signal from other objects that are too far from the evanescent field to become excited.

The disclosed systems may, however, utilize standard wide-field illumination. Because fluorescent objects (e.g., fluorescent labels attached to polynucleotides) are constrained close to the surface of the chip or stage, there is very little background signal from other sample material in the vicinity of the specific molecule under analysis. As shown in the bottom panel of the figure (which figure is a head-on view of a nanochannel array that contains polynucleotide samples), nanochannels act to constrain the sample polyoligonucleotides close to the surface of the chip or stage. The channels may be dimensioned such that they accommodate a single polynucleotide.

Autofocus System

An autofocus system may employ a separate infrared laser coupled with a multi-position sensor to monitor the distance between the imaging lens and the sample plane. The system runs autonomously from all other components of the system and can perform primary focusing (i.e. find the correct focus position) and track the focus position once found. The system can make adjustments with a precision of 10 nm at frequencies of 100 Hz, although such precision is not a requirement, as precision of 100 nm, or even 1000 or 5000 nm is suitable. Frequencies of less than 100 Hz (e.g., 50 Hz, 20 Hz, 10 Hz, or even 5 or 1 Hz) are suitable. Such precise adjustments are achieved using a piezoelectric drive that precisely controls motion of the main imaging lens. The autofocus system may be adapted to work with the nanochannel arrays; the specific geometry of the array results in an optical response that must be accommodated by the autofocus unit. Sub-100 nm features are not uncommon Sharp focus of each field of view can be maintained by dynamically moving the array above the objective lens while imaging at capture rates of 1, 10, 20, 50, or 100 frames/second. The autofocus system enables reliable, robust imaging and image analysis of a sample. An exemplary system is set forth in patent application PCT/US2010/035253, “Devices And Methods For Dynamic Determination Of Sample Spatial Orientation And Dynamic Repositioning,” filed May 18, 2010, and incorporated herein in its entirety.

A schematic view of a suitable autofocus system is shown in FIG. 13. As shown in that figure, a sample is illuminated by collimated light (e.g., a laser), which then reflects from the sample and is collected by a radiation detector (e.g., a CCD or CMOS device). The system may then compare the location of the reflected beam on the detector with the location of the beam that corresponds to optimal focus and may then move the sample stage accordingly so that the reflected beam lies on the location on the detector that corresponds to optimal focus.

Multi-Color Fluorescence Detection

The system is designed to detect fluorescent signals of differing wavelengths. A multi-position high speed filter wheel allows for discrimination of multiple (e.g., 10) fluorescent colors, which allows for multiplexing. Many different fluorescent moieties can be used, including organic fluorophores, quantum dots, dendrimers, fluorescent beads and metallic dots. The system can deliver sensitivity at the single fluorophore level; the optimal configuration will depend on the nature of the fluorescent moiety and the requirements of the assay. This enables the user, in some embodiments, to detect the presence of a single label (e.g., a fluorophore linked to a base) is present in a sample.

High Sensitivity Camera

The system may also include a camera to record images of individual fluorescent molecules. An electron multiplying CCD camera with high quantum efficiency covering the entire emission spectra of fluorescent stains and dyes is considered particularly suitable. Although other types of cameras and detection devices can also be accommodated performance and efficiency suffers. The camera may also be cooled below room temperature to minimize the impact of thermal and minimize electron noise. Temperatures of about −20 C to about −100 C may be used to cool the camera. For applications that are less demanding in their fluorescent sensitivity, detectors without electron multiplying capability are suitable. These include conventional CCDs, CMOS detectors, photomultipliers and photodiodes. The system can include photon-counting capability, which capability is useful for certain single molecule analysis applications. Suppliers of suitable such devices include Princeton Instruments Cascade, Hamamatsu ImagEM, Andor iXon and Neo SCMOS,

Stage

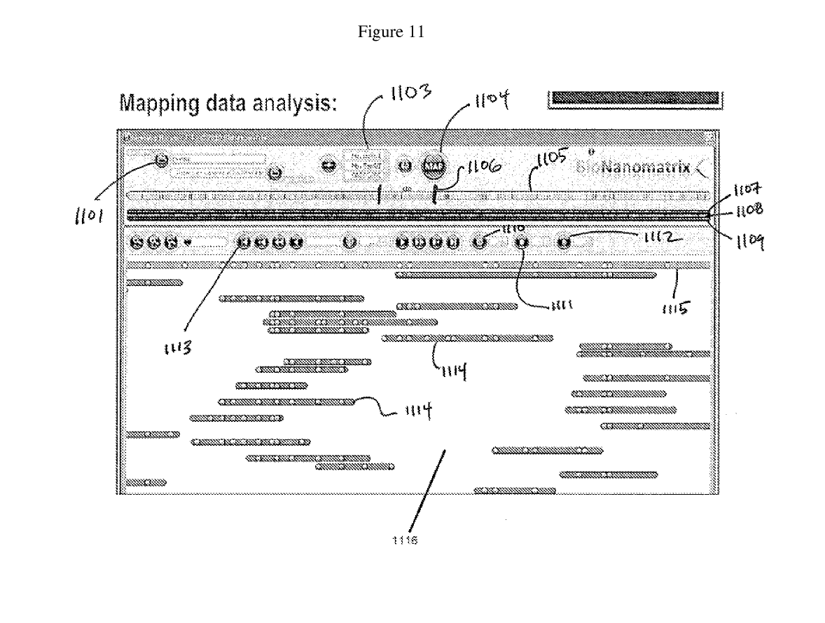

The system suitably includes a XY stage capable of sub-100 nm precision when moving from one field of view to the next, although precisions in the range of 10s of nm, 100s of nm, or even 1000s of nm are suitable. The stage may accommodate a nanochannel array chip. During data collection, the stage (in some embodiments) executes a raster scan routine during which the nanochannel array is imaged in part or in whole. Multiple images may be collected so as to address an entire array of nanochannels. These images are then stitched together to generate a composite view of the entire array. The precision of the stage enables a stitching-together of the images. Stitched images allow detection of biomolecules larger than a single field of view, i.e. 1 MB fragment of DNA. An exemplary image is shown in FIG. 11, which figure shows a visual representation of the presence of various labels on various regions of a polynucleotide. The various polynucleotide segments may, for example, be the products of a digestion of the polynucleotide. Each segment may then be assessed for the presence or absence of various types of damage by inspecting the processed segment for the presence or absence of labels that correspond to the different types of damage. The user may then assemble the various segments into a cohesive map of the entire polynucleotide, which map includes the location or locations of the various types of damage the polynucleotide may have suffered.

FIG. 11 is an exemplary screenshot that illustrates application of the disclosed systems and methods. In this view, the upper left corner two file folders icons 1101 allow users to select and upload various files (e.g., reference files or sample data files). The middle three stacked windows 1103 adjacent to the “Map” button 1104 represent enzymes that bind to a specific sequence motifs, e.g., nicking enzymes, restriction endonucleases, homing enzymes, methyltransferases, or even the specific sequence motif itself, such as CTCCAGC or other sequence.

The horizontal bar 1105 with vertical grey stripes, immediately below these buttons, is a schematic of the target genomic region (uploaded file in the upper left corner) with a theoretic grey scale barcode reflecting the GC content of the region, darker of higher GC content, lighter more AT rich, and the like. A toggle region 1106 (defined by the two thicker vertical bars) may be slid along the region, with the area enclosed within the toggle shown in the window below. A user may also use control buttons 1113 to more forwards or backwards along the polynucleotide being analyzed. A user may also input a specific base position of interest to set the region to be shown and expanded in larger window 1116.

The three horizontal lines (1107, 1108, and 1109) may include dots (including colored dots) or other icons, which dots or icons show the predicted labeling/cutting sites would distribute throughout the region, if one were to select these individual enzymes/sequence motifs in the windows above. Below these lines 1107, 1108, and 1109 are three buttons 1110, 1111, and 1112, each of which can be used to display the number of labels on the sample, so as to allow the user to assess the labeling density on the sample. For example, if the user were to click on button 1110, the window would display the highlighted genomic region showing where the labels that correspond to that button are. Such labels may represent the result of labeling from nicking enzyme Nb.NbvcI. By clicking on another button (e.g., button 1111), the user may visualize labeling derived from enzyme BspQI.

The stacked segments 1114 represent actual digitized data generated from images of labeled sample. The system may align the signature patterns of different segments of the sample, in total or partial overlaps alignment with each other. Reference bar 1115 may then show this combined mapped information. Alternatively, these visual “nano-contigs” could can form a consensus contiguous positional signature pattern that reflects true structural information of the genomic region. This may also provide a reference map for sequencing in the case of de novo sequencing, in that there are no reference sequence files to upload or compare against in the first instance.

Touch Screen Interface with User Friendly Control Software

The system may include a graphical user interface. Such an interface may comply with ISO 13485 and FDA 12 CFR 11 guidelines, depending on the user's needs. The interface may support separate user level login. A graphic user interface may be used to minimize user interaction and to simplify run recipe setup. A resistive touch screen may be used to translate user input for run recipe setup parameters. Run recipes and operations are user-definable and can be tailored for specific experiments or applications allowing for easy comparison of results from similar runs. Run results can be analyzed on board or data can be exported for archival or detailed analysis on a separate computer workstation.

Custom Microcontroller for High Throughput Image Acquisition at Run-Time

A separate microcontroller, acting as a slave, may be used for managing and synchronizing events necessary for high speed image capture. The controller may act to synchronize the laser with the camera exposure and ensures that the filter wheel and XY stage respond immediately after the image is captured. The microcontroller interprets run recipe parameters entered by the user into a sequence of executable commands. These commands provide sample voltage loading conditions, laser sequence order, and laser pulse time durations, scan repetition number, and the like.

On-Board Computer with Custom Control Software

A software application may be run on an on-board computer, with the application acting as a master to the microcontroller slave. The custom software application translates user run recipe input plus data analysis parameters and provides a conduit for direct subassembly component interactions. The software application may suitably be compliant with ISO 13485 and 21 CFR 11, depending on the user's needs.

Electrode Bundle and Evaporation Control

In some instances, nanochannel sample reservoir evaporation can impact run results. An electrode bundle may be used to mitigate and control sample reservoir evaporation.

Samples are loaded into the reservoirs along with run buffers to effect molecule loading of nanochannels. An electric field is used to load the samples as they carry an electric potential, positive or negative. The electric field sample loading is input by the user as part of the run recipe and controlled by the microcontroller. E-field loading parameters can be either positively or negatively charged, dictated by the net charge of sample being loaded. These are, in some cases, optimized in 0.1 VDC increments, although finer resolution may be used. Optimization is a function of sample net charge, sample length and molecular make-up, and the user may set specific e-field loading parameters for each molecular species as desired. The systems may be configured to add additional buffer or other solutions when needed so as to maintain or achieve a particular fluid content within the system. In one embodiment, the electrodes are supported by a Teflon block that nests or otherwise engages with the fluidic chip. This nesting action provides a seal between the electrodes and chip reservoirs that serves to minimize interaction with the surrounding environment. In this way, evaporative loss to the environment is minimized. Electric field may be applied by electrodes immersed in the sample input and output wells. Voltage is suitably applied in the range of 0.1-100 V over fixed times that can range from 0.1 s to several minutes. Standard op-amps are used to apply the voltage and are controlled by a microcontroller.

Wide-Field Illumination for Single Molecule Imaging of Non-Tethered Molecules

Existing single molecule imaging approaches rely on total internal reflection (TIRF) to achieve single molecule sensitivity. In this configuration, excitation light is incident at an angle (TIRF angle) resulting in an evanescent electromagnetic field near the surface of the imaging plane. This evanescent field typically extends 100 nm above the imaging plane. Any fluorescent moieties exposed to this field are fluorescently excited, thus producing emitted light than can be detected using an appropriate fluorescent detector. Fluorescent objects outside of the range of this evanescent field are not excited and thus do no contribute to the background fluorescent signal.

TIRF, however, has several disadvantages. First, the optics are sensitive to alignment. The incident light must impinge upon the sample at the correct angle, otherwise no evanescent field will be produced. Second, the limited volume within which objects can be detected often requires that the objects be tethered to the surface to prevent them from migrating away from the imaging plane via thermal diffusion. This requires additional chemical or physical tethering mechanisms.

The disclosed systems operate with nanochannel arrays to permit the use of standard wide-field imaging for single molecule detection. The nanochannel array is used to constrain fluorescent (or other labeled) moieties near to the imaging plane. Because of this, there is little possibility of background fluorescence from other moieties. This obviates the need for TIRF imaging, in turn allowing a simpler and more stable optical system. Furthermore, because the molecules are restricted from diffusing away from the imaging plane, the fluorescent moieties do not need to be tethered to the surface.

A further feature of the disclosed systems system is the incorporation of an autofocus system capable of working with nanochannel devices and arrays, as samples are imaged on the system. The autofocus system uses an additional laser which is collinear with the main excitation lasers. This allows for integration of this sub-system with the main imaging components. Furthermore, the autofocus system may be specifically aligned to work with nanochannel arrays being imaged on the disclosed systems. Other autofocus systems are generally designed to work with a featureless glass substrate and will either not directly integrate with other components in the system or cannot accommodate a nanostructured surface such as that of a nanochannel array.

High Speed Automated Operation

The disclosed systems are capable of accommodating high speed imaging with single molecule sensitivity. The filter wheel, camera, XY stage and lasers are suitably selected and configured to permit imaging at 10, 20, 30, or even more frames per second. Suitable stages are available from, e.g., Aerotech, Physik Instrumente, and Applied Scientific Imaging. Suitable filter wheels are available from, e.g., Sutter Instrument Company, Finger Lakes Instrumentation, and Applied Scientific Imaging. Suitable lasers may be purchased from, e.g., Cobolt AB, Crystal Laser, and other vendors of optical equipment. The speed of each individual device may be coordinated by a microcontroller that sequences the various operations during the imaging routine. In one embodiment, to acquire an image, the XY stage moves to the field of view of interest at which point the excitation laser is fired and the camera is set for image acquisition. This raster type sequence is repeated until the entire nanochannel array has been imaged.

The imaging speed is then coupled with the automated loading sequence enabled by the electrode bundle. Using appropriate voltages for the sample of interest (for example, ranging from −30V to +30 V), the sample is loaded into the array in preparation for imaging. The loading sequence can then be repeated after each imaging scan, in turn allowing for rapid data collection. As an example, when using double-stranded DNA, data acquisition rates representing up to 1 Gbp per minute of imaged DNA can be achieved. The automation and autonomous sequencing of events provides for an easy to use platform requiring minimal user intervention and minimal maintenance. The system also accommodates automated loading of nanochannel arrays and automated dispensing of sample. This allows integration with robotic systems, further improving throughput and overall speed of analysis.

Variety of Samples Accommodated

The systems are also designed as an open platform in the sense that a broad range of sample types can be accommodated. Suitable samples include biological samples such as DNA, RNA, proteins, biopolymers, and other complexes that include such species. Other macromolecules such as polymers, dendrimers, oligomers, and the like can also be analyzed. When a sample or sample analysis may require particular environmental conditions such as heating or cooling, such requirements can also be accommodated according to the sample type and specific requirements, as heaters, coolers, and fluid/gas sources can also be incorporated into the disclosed systems.

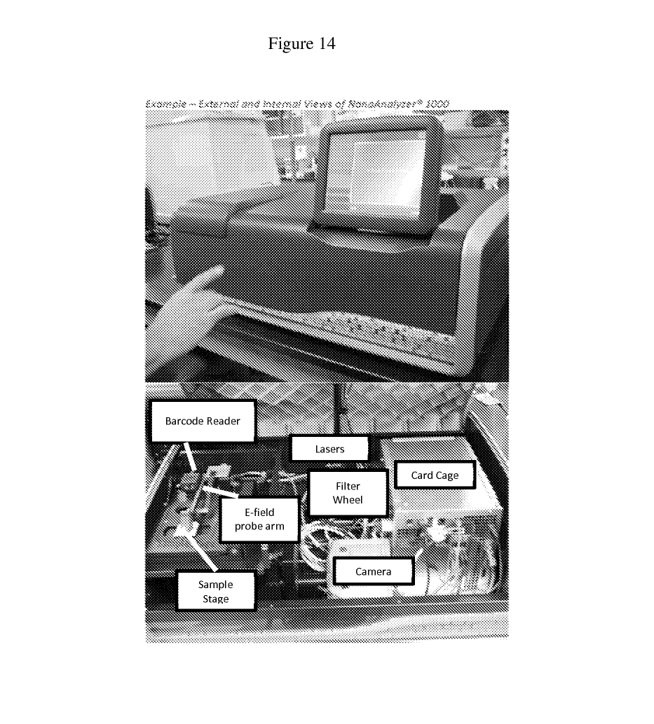

An exemplary system is shown in FIG. 14. That figure shows (upper panel) an exterior view of the system, which exterior view includes the cabinet (which encloses the various system modules and units) and a touch screen controller, which may be used to provide user input to the system and also to present data gathered by the system.

The lower panel of FIG. 14 presents an interior view of the exemplary system. As shown in that view, the system may include a sample stage, which stage engages with a nanochannel-bearing chip or other substrate. The stage may be moveable in response to reflected illumination from the sample. The system may include a barcode reader, which reader may read information from a barcode or other indicia present on the fluidic chip, which information may be used to configure one or more aspects of the system, such as illumination wavelength. The system may also include an e-field probe arm, which probe arm may be used to sense or even apply an electric field to a sample disposed within the fluidic chip (or to draw the sample into the chip). One or more lasers may be used to apply the illumination to the sample, and a filter wheel may be used to filter applied or reflected illumination. The camera acts to collect illumination reflected or emitted from the sample. A card cage contains various processing and control units.

A barcode may be applied to a chip by way of an adhesive label, or, in some cases, is inscribed directly on the fluidic chip. When the system reads the barcode, it can determine, for example, (a) whether the chip has already been used; and (b) if the chip is designed to support a particular assay.

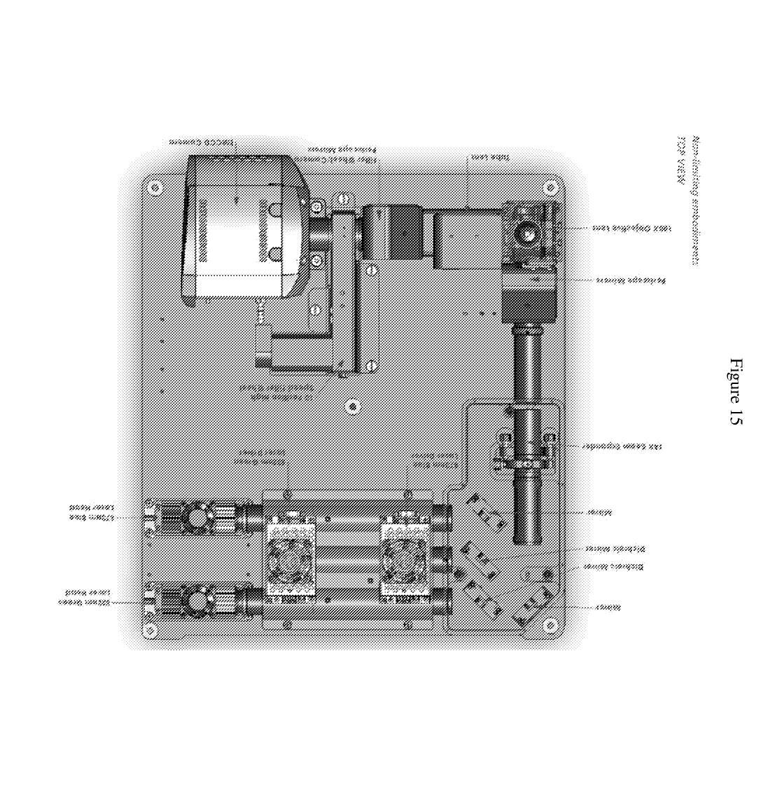

FIG. 15 presents a detailed view of the components of an exemplary system. At the upper right hand corner of the figure is shown two lasers (523 nm and 473 nm). These wavelengths are not mandatory, and a user may use lasers or other illuminators as desired. The illumination from the lasers is passed among mirrors and dichroic mirrors, and may be passed through a beam expander. A illustrative 14× beam expander is shown, although other beam expanders may of course be used. A periscope mirror is used to direct the illumination beam to and from the sample, which sample is positioned above the objective lens. A tube lens may be used to carry illumination toward the EMCCD camera shown at the lower right of the figure.

A filter wheel and periscope mirrors may be used to provide only certain wavelengths to the camera, thus enabling the camera to image, visualize, or even discriminate between different labels. The filter wheel may be motorized so as to enable rapid positioning of one or more filters in the optical train of the system. As one non-limiting example, a filter wheel may include a multi-position rotary wheel driven by a stepper motor with optical encoder. Typical filters would include dielectric coated glass providing either bandpass, low pass, or high pass filtering of fluorescence illumination. Typical center wavelengths are in the visible spectrum (400-700 nm), but are not limited to this range. In the case of bandpass filters, typical bandwidth is 30-60 nm, but may be of other ranges.

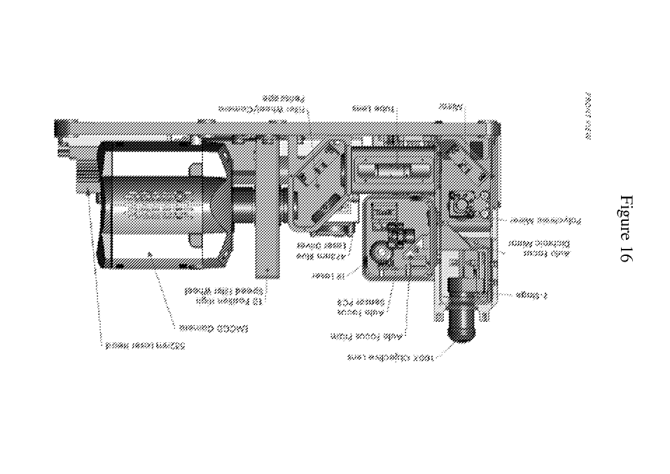

FIG. 16 provides an alternative view of the system shown in FIG. 15. At the right side of the figure is shown the 532 nm laser head. The laser head lies behind (in this view) the EMCCD camera. The camera is in optical communication with a filter wheel.

In this view, an objective lens is shown at the left hand side of the figure, the objective lens being positioned above the stage. The stage is suitably moveable in the z-direction so as to place the sample into focus for imaging. As described elsewhere herein, the movement of the stage is suitably modulated by a controller, which controller actuates the stage based on an autofocus system.

As shown in the left hand side of FIG. 16, there may be an autofocus dichroic mirror positioned to direct illumination that is reflected from the sample to an autofocus sensor. The illumination used in the autofocus components may be in the infrared region, as illustrated by the IR laser unit present in the autofocus module. IR illumination is not a requirement, as illumination using other wavelengths may also be used. The autofocus prism may direct illumination to or from a sensor or detector.

Based on the location of the reflected illumination on the autofocus sensor or detector, the system may move the stage (and sample) up or down to place the sample into optimal focus. As described in, e.g., patent application PCT/US2010/035253, “Devices And Methods For Dynamic Determination Of Sample Spatial Orientation And Dynamic Repositioning,” filed May 18, 2010 (incorporated herein by reference in its entirety), the autofocus system may record a reference spot on the detector that corresponds to the illumination reflected from the sample at optimal focus, and then adjusts the position of the stage so as to maintain the reflected illumination at that reference spot.

For example, the user and system may determine that when a sample is in optimal focus, a beam of IR radiation generated from the IR laser and reflected from the sample strikes the autofocus detector at location x1, y1. If, during processing, the beam strikes the detector at location x2, y2, the system may translate the stage upwards or downwards (or may even tilt the stage) so as to return the beam-strike location on the detector to x1, y1.

The view shown in FIG. 16 also illustrates a mirror and an exemplary tube lens (shown at the bottom of the figure) that are used to direct illumination from an illuminated sample to the filter wheel and EMCCD device. A periscope mirror arrangement may be used to direct illumination from the tube lens to the filter wheel region and to the EMCCD camera.

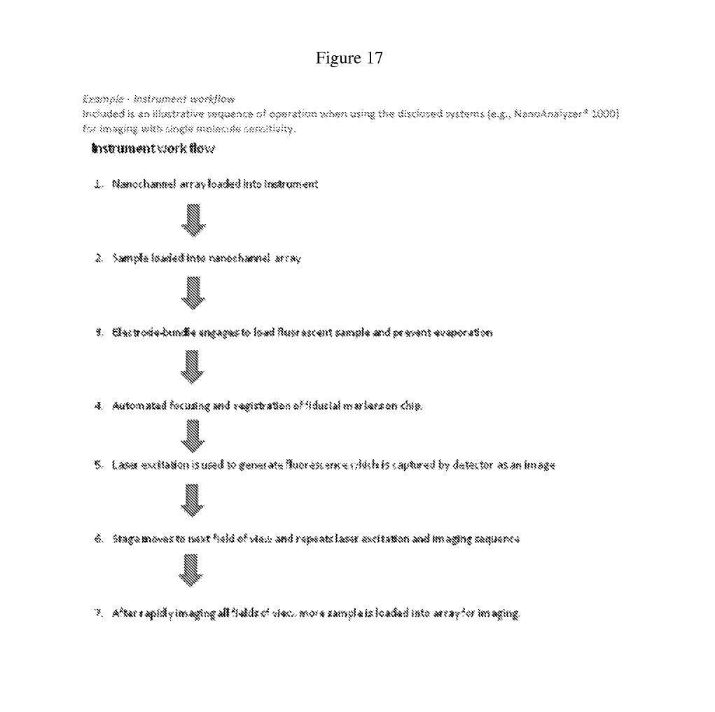

FIG. 17 illustrates an exemplary sequence of operations according to the present disclosure. As shown in the figure, a user may begin by loading a nanochannel array (e.g., in the form of a cartridge or chip) into an analyzer system. The sample may then be loaded (suitably in fluid form) into the nanochannels. An electrode bundle may then engage to load the sample into the array. Because polynucleotides can be charged or may include one or more charged groups, application of an electric field may act to load the sample into the channels. The imaging components of the system are suitably focused onto the sample, using the autofocus methods described herein, the methods described in patent application PCT/US2010/035253, or by other suitable autofocus methods known to those of ordinary skill in the art.

An illumination source (e.g., a laser) is then used to generate fluorescence from one or more labels, which is then collected by an image collector. The stage, illumination source, or both, may then move such that a different portion of the stage and a different sample are illuminated, and the system gathers information from this next sample. The system may image any or all fields of view of a given sample.

The present disclosure provides other methods, the methods including contacting a first single-strand break in a polynucleotide with an alkaline phosphatase so as to give rise to a first moiety capable of supporting polymerase extension; contacting the moiety with a polymerase and a labeled nucleotide so as to incorporate a label into the polyoligonucleotide; linearizing at least a portion of the polynucleotide by confining the first label within a nanochannel; and imaging the first label.

A variety of alkaline phosphatases may be used; shrimp alkaline phosphatase is considered especially suitable for the disclosed methods. Suitable linearizing and imaging methods are described elsewhere herein. The user may also, as described in this disclosure, correlate the presence or location of the labeled nucleotide (or multiple labeled nucleotides) to a structural characteristic of the polynucleotide.

Additional methods disclosed herein include applying to a single-strand break in a polynucleotide a DNA polymerase having 3′ to 5′ exonuclease activity so as to convert the non-extendable single strand break into a polymerase-extendable sites; and applying a DNA polymerase and a labeled deoxynucleotide so as to incorporate a label into the polynucleotide. Suitable labels are described elsewhere herein, and include fluorophores (e.g., fluorescein, YOYO, Texas Red, and the like). This technique can be used to label non-OH-3′ modifications. A variety of fluorophores are available from Fisher and Sigma chemical suppliers, as well as from Molecular Probes (www.molecularprobes.com). The polymerase of the disclosed methods is suitably applied essentially in the absence of free nucleotides or even free deoxynucleotides.

This disclosure also provides additional methods, which methods further include disposing a polynucleotide having an abasic site within a porous matrix material; contacting the polynucleotide with an alkaline material so as to covert the abasic site to a single strand break in the polynucleotide, so as to convert a single strand break in the polynucleotide to a double strand break in the polynucleotide, or both; converting a single strand break in the polynucleotide, a double strand break in the polynucleotide, or both, to a moiety capable of supporting polymerase extension; contacting the moiety with a polymerase and a labeled nucleotide so as to incorporate one or more labels into the polynucleotide. The user may then, as described elsewhere herein, image or otherwise locate or detect the one or more labels.

With that information, the user may further correlate the presence or position of one or more labels to a structural characteristic of the polynucleotide, as described elsewhere herein. A user may further—in any of the disclosed methods or systems—correlate the structural information of the polynucleotide to a damage state or even a disease state.

The polynucleotide may, in some embodiments, be disposed within a cell. The cell may in turn be lysed so as to liberate the polynucleotide. The user may amplify the polynucleotide, digest the polynucleotide, or any of the foregoing. The cell, the polynucleotide, or both, may be disposed within the porous matrix material. Converting a single strand break in the polynucleotide may be accomplished by contacting the single strand break with an endonuclease having 3′ phosphodiesterase activity.

The user may at least partially decompose the matrix material so as to liberate the polynucleotide. The polynucleotide may be processed while it resides within the porous matrix, or it may be processed outside of the matrix. As described elsewhere herein, the use of the porous matrix can reduce or even eliminate fluid handling steps that give rise to shear forces that can in turn damage the polynucleotide. Also as described elsewhere herein, the user may image one or more labels and correlate the imaged label to a structural characteristic of the polynucleotide. It should be understood that “imaging” does not require that an image or other depiction of the polynucleotide under analysis be displayed on a monitor or other devices for the user to view. Instead, the term “imaging” should be understood to refer to collecting illumination reflected or emitted from a label. Further processing of that collected illumination can include construction of a video or other image that enables a user to view the label in position on the polynucleotide.

Other methods provided herein include disposing a polynucleotide within a porous matrix material; converting a first site on a polynucleotide to a first moiety capable of supporting polymerase extension; effecting extension at the first moiety so as to incorporate a first label at or proximate to the first site; linearizing at least a portion of the polynucleotide by confining the first label within a nanochannel; and imaging the first label. As described elsewhere herein, a user may correlate the imaged label to a structural characteristic of the polynucleotide, or even to a damage or disease state of the polynucleotide's donor. The polynucleotide may be disposed within a cell, which cell may be lysed and may also be disposed within the porous matrix. The user may further (a) lyse the cell so as to liberate the polynucleotide, (b) amplify part or all of the polynucleotide, (c) digest the polynucleotide, or even some combination of the foregoing. The user may also at least partially decompose the matrix so as to liberate the polynucleotide. This may be effected by heat, light, chemical exposure, microwaves, or by other methods useful in decomposing matrix materials.

Converting the first site may be effected by contacting the first site with an N-glycosylase. Suitable N-glycosylases are described elsewhere herein. Extension may be accomplished by contacting the polynucleotide with a polymerase and a nucleotide comprising the first label, as described elsewhere herein. The user may, as explained above, also correlate the presence or location of one or more labels to a structural characteristic of the polynucleotide.

Kits according to the present disclosure suitable include a quantity of an N-glysosylase; a quantity of an apurinic/apyrimidinic lysase, a 3′-phosphodiesterase, or both; a quantity of a polymerase; and a quantity of a labeled nucleotide.

Suitable agents are described elsewhere herein. The reagents of the kit may be disposed within a package adapted to engage with a device capable of effecting dispensation of one or more of the kit's reagents. As one example, the kit may include pouches of the foregoing agents, and the kit may then be insertable into a receiver of the system, with the receiver being configured to apply pressure to the appropriate pouch so as to apply the appropriate reagent to a sample. The kit may include entrance and exit ports, which ports may be used for the passage of agents into or out of the kits.

Other kits according to the present disclosure include a quantity of an alkaline material; a quantity of an apurinic/apyrimidinic lysase, a 3′-phosphodiesterase, or both; a quantity of a polymerase; and a quantity of a labeled nucleotide. These kits may be used to perform the methods described elsewhere herein, which methods include the formation of polymerase-extendable sites on damaged polynucleotides.

Alternative systems are also provided herein. These systems suitably include a kit that includes (a) a quantity of a polymerase, (b) a quantity of a labeled nucleotide, and (c) a quantity of one or more of an apurinic/apyrimidinic lysase, a 3′-phosphodiesterase, or Endonuclease IV, the kit being adapted to engage with a sample imager, the sample imager comprising a sample stage adapted to engage with a fluidic chip that includes one or more nanochannels, an illumination source capable of optical communication with a sample disposed within a nanochannel of the fluidic chip, and an image collector capable of collecting an image of an illuminated sample disposed within the nanochannel.

Additional methods disclosed herein also include linearizing a region of a polynucleotide that includes at least one label, the label having been incorporated into the polynucleotide by polymerase extension, the polymerase extension being performed on a moiety that was converted from an abasic site, a single strand break, or both.

Incorporation and conversion approaches are described elsewhere herein. The methods may also include imaging the at least one label. Linearizing may be accomplished by the other methods presented in this disclosure, which methods include confining the region of a polynucleotide that contains at least one label within a nanochannel. The user may then correlate the presence or location of one or more labels to a structural characteristic of the polynucleotide. The user may also correlate the presence or location of the labels or even the structural characteristic of the polynucleotide to a disease or damage state of the polynucleotide.

This disclosure also provides methods, the methods including incorporating a label at or proximate to a site of damage on a polynucleotide; linearizing a region of the polynucleotide that includes the label; and imaging the label. The user may determine the presence, spacing, or both, or two or more labels on the polynucleotide. The user may then correlate the presence or location of one or more labels to a structural characteristic of the polynucleotide. The user may also correlate the presence or location of the labels or even the structural characteristic of the polynucleotide to a disease or damage state of the polynucleotide.

Label incorporation is suitably accomplished by converting the site of damage to a moiety capable of supporting polymerase extension. The conversion may include converting the site of damage to an intermediate. The intermediate is in turn suitably converted by one or more steps to the moiety capable of supporting polymerase extension.

Alternative systems are also provided by the present disclosure. These systems suitably include a base configured to receive a fluidic chip; an illuminator configured to illuminate a polynucleotide sample disposed within the fluidic chip; and an image collector configured to collect an image from the polynucleotide sample disposed within the fluidic chip.

These systems (and the other systems disclosed herein) may include an optical medium placing the illuminator into optical communication with a sample disposed within the fluidic chip. The optical medium may be a fiber, a lens, a mirror, and the like. The system may also include one or more filters that are capable of changing the wavelength of illumination supplied by the illuminator to the polynucleotide sample.

Systems may also include a gradient source capable of communicating with the polynucleotide sample disposed within the fluidic chip. The gradient source may include a source of pressure, a source of electrical potential, a source of current, a magnetic field source, or any combination thereof. The illuminator may be a laser, a LED, or other source of illumination known to those of ordinary skill in the art. The system may be configured to apply illumination of two or more wavelengths to the polynucleotide sample, as described elsewhere herein.

The disclosure thus provides methods of assessing DNA damage. These methods also include correlating detected DNA damage to the quality of genomic DNA based on success or failure in downstream sequencing assays. This assessment may be effected by comparing the label profile (i.e., location of labels and types of labels) of the damaged DNA under analysis to the label profile of control DNA. For example, a user may compare the label profile of a DNA sample (i.e., possibly damaged) to the profile of a control (undamaged) DNA sample to determine whether the sample DNA contains any damaged locations.

The user may also assess the quality (including the degree of DNA damage) of genomic and cDNA libraries for sequencing or other assays. That includes the measurement of library insert size, fragment size distribution, fragment size uniformity, as well as library DNA damage such as double strand breaks, single strand nicks, abasic sites, base lesions, DNA adducts, fragment end quality assessment (for adaptor ligation, vector ligation, and the like). The user may assess the quality of a library or individual clones, by correlating data derived from measuring backbone labeling of library DNA fragments, and/or DNA damage specific site labeling along these fragments.

The disclosed systems enable users to identify and analyze small biological samples (e.g., DNA) on a single-molecule and on a molecule-by-molecule basis, in parallel format. The system provides high-resolution analyses of macromolecules, which in turn enables performance of numerous (and new) applications in the fields of life science research, clinical research, diagnostics, and personalized medicine.

Typical complex genomes are composed of multiploid chromosomal DNA. Each individual chromosome can range from hundreds of thousands to hundreds of millions of base pairs in length. These molecules can be conceptualized as semi-flexible biopolymers that form ball-like random coils in solution when extracted from cells.

The disclosed methods, using nanochannels, can unravel, sort, elongate, and/or confine native state genomic DNA fragments (and other polymeric molecules) into an orderly, linear format. The technology does not require front-end amplification or shearing of the sample DNA into small fragments, and thus preserves clinically valuable genomic structural information such as copy number variations (CNVs), balanced lesions, or other such genomic rearrangements and features. Because of the single-molecule analysis capability of the technology, only minute quantities of sample are required, which represents a departure from other genomic analysis platforms.

### Exemplary Embodiments

The following are exemplary embodiments of the disclosed methods and systems. These embodiments are illustrative only and should not be read as limiting the scope of the present disclosure.

Detection of DNA Size Distribution in Nano-Channel Array

In one model system, DNA samples are prepared using various DNA sample preparation kits, including Buccal swab DNA using Gentra PureGene™ kit, cultured cell DNA using Gentra PureGene™ kit, and cultured cell DNA using Easy DNA™ kit.

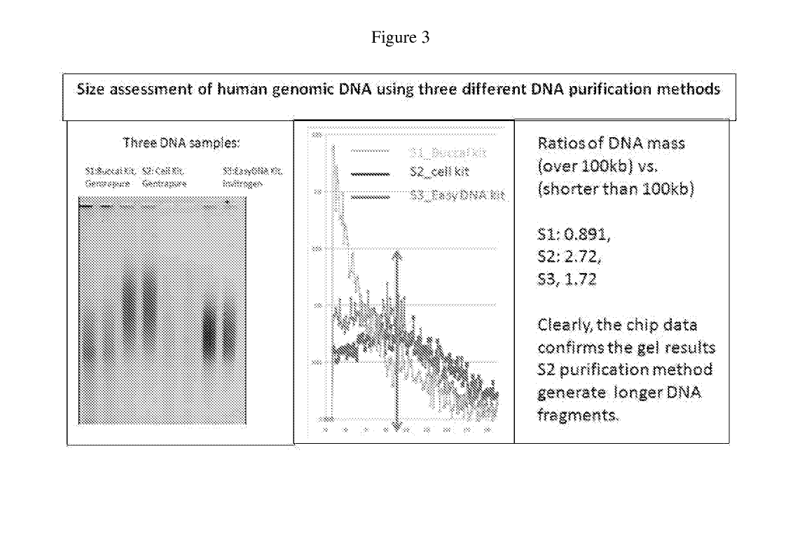

The three samples shown in FIG. 3 demonstrate a different size distribution on pulse-field gel. Without being bound to any single theory, this difference in size distribution is due to purification-induced damage in the form of double strand breaks (DSBs). Purification-induced DSBs can be assessed by analyzing the size distribution of DNA imaged within a nanochannel array, as described elsewhere herein. DSBs can be quantified based on shifts in the center of mass toward a lower DNA length, on a decrease in the percentage of DNA molecules above certain length, or even on a decrease in the percentage of DNA molecules between a certain range of lengths (FIG. 3).

Detection of DNA Double Strand Breaks Due to UV Damage in Nano-Channel Array.

UV radiation of DNA induces not only two of the most abundant mutagenic and cytotoxic DNA lesions such as cyclobutane-pyrimidine dimers (CPDs) and 6-4 photoproducts (6-4PPs) and their Dewar valence isomers, such exposure may also generate double strand and single strand DNA breaks. Because of double strand DNA breaks caused by UV radiation, the length distribution of damaged DNA molecules will shift to a shorter length, and in turn the amount of double strand breaks can be inferred from DNA length measurements.

Detection of Single Stranded Breaks Due to UV Damage in Nano-Channel Array:

Single strand DNA breaks caused by UV radiation can be measured in nanochannel arrays as described above. In one embodiment, one may incorporate fluorescent dye nucleotides at these break sites by action of DNA polymerase, which polymerase acts to incorporate the labeled nucleotides at the break site. The labeled DNA molecules are then elongated (e.g., into linear form) in a nanochannel array and can be individually imaged using fluorescent microscopy. By determining the location(s) of these fluorescent labels along the DNA backbone, the distribution and the density of the single strand breaks can be established with accuracy.

Detection of UV-Induced Cyclobutane Pyrimidine Dimers with T4 Endonuclease V and Vent Polymerase in Nano-Channel Array.

UV radiation induces two of the most abundant mutagenic and cytotoxic DNA lesions: cyclobutane-pyrimidine dimers (CPDs) and 6-4 photoproducts (6-4PPs) and their Dewar valence isomers. T4 Endonuclease V, however, functions as part of the base-excision repair pathway and recognizes and removes pyrimidine dimers. The enzyme then cleaves the glycosyl bond of the 5′ pyrimidine of the dimer and the 3′ phosphodiester bond, which in turn results in an SSB in the DNA. The resulting nick site contains a free OH group at 3′ end of DNA molecules, and a Vent (or other) polymerase may then be used to incorporate fluorescent nucleotides at the break site. The labeled DNA molecules are then elongated within nanochannels and are then imaged using multicolor fluorescent microscopy.

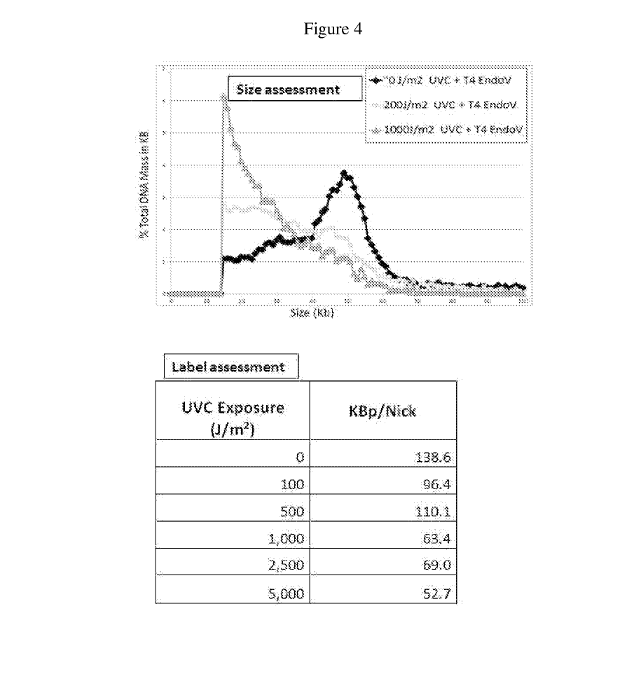

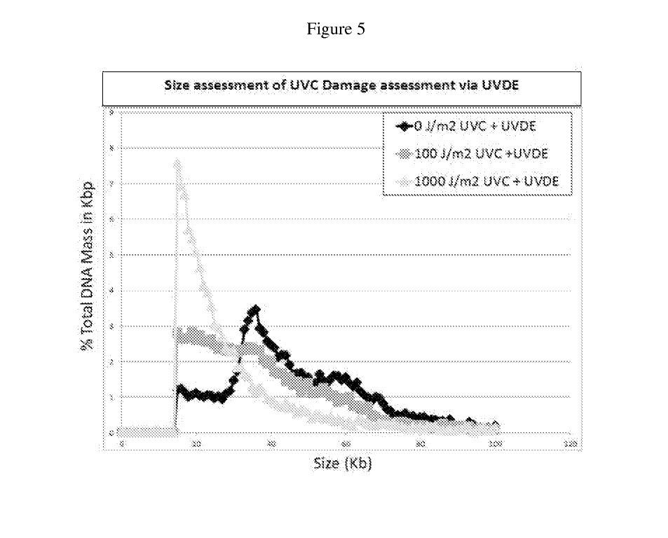

By determining the location of one or more fluorescent labels along the DNA backbone, the distribution and the density of UV-introduced cyclobutane-pyrimidine dimers can be established with accuracy (FIG. 4). Additionally, frank DSBs and DSBs due to clustered UV damage that are converted to SSBs can be measured by generating a size distribution of molecule lengths (FIG. 4). A similar size distribution assessment was made for DNA subjected to UVC damage but incubated with UVDE (UV damage endonuclease) (FIG. 5). This distribution demonstrates a dose response to damage in terms of molecule size.

It should be understood that fluorescent imaging is not the only way in which a nucleotide may be detected. Nucleotides may also be labeled with a radioactive material, such as an isotope, which radioactive material may in turn be detected and located after the nucleotide has been incorporated into the polynucleotide sample. Fluorescent imaging is considered especially suitable.

Damaged Bases Recognized and Labeled by Endonuclease IV and Vent Polymerase, and Detected in Nanochannel Array:

Endonuclease IV can act on a variety of oxidative damage in DNA. The enzyme is characterized as an apurinic/apyrimidinic (AP) endonuclease that will hydrolyse intact AP sites in DNA. AP sites are cleaved at the first phosphodiester bond that is 5′ to a lesion, leaving a hydroxyl group at the 3′ terminus and a deoxyribose 5′-phosphate at the 5′ terminus. The enzyme also has a 3′-diesterease activity and can release phosphoglycoaldehyde, intact deoxyribose 5-phosphate and phosphate from the 3′ end of DNA.

Damaged Bases Recognized and Labeled by Formamidopyrimidine DNA Glycocylase (FPG) and Vent Polymerase, and Detected in Nano-Channel Array.

Formamidopyrimidine DNA glycocylase is a member of the base-excision repair (BER) pathway of DNA repair enzymes. FPG functions as both an N-glycosylase and AP-lyase. FPG recognizes and excises damaged bases from double-stranded DNA and hydrolyses the N-glycosyl bond creating an apurinic/apyrimidic (AP) site. This enzyme cleaves the 3′ and 5′ phosphodiester bonds of AP sites producing a gap in the DNA leaving 3′ and 5′-phosphate termini. FPG identifies and removes many modified bases with mutagenic potential including: 8-oxoguanine, 8-oxoadenine, formamidopyrimidines (FapyA, FapyG, methyl-fapy-guanine, aflatoxin B₁-fapy-guanine), 5-hydroxy-cytosine, 5-hydroxy-uracil and ring-opened N-7 guanine adducts (7-methylguanine).

Damaged Bases Recognized and Labeled by Endonuclease III and Vent Polymerase, and Detected in Nano-Channel Array.

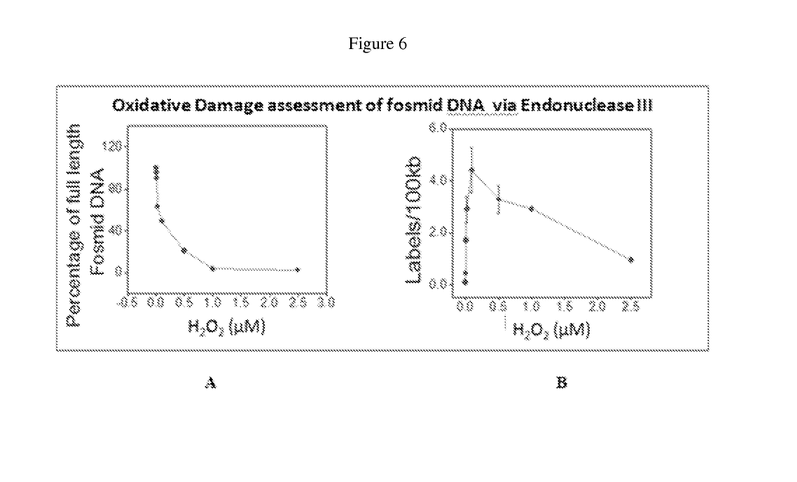

Endonuclease III is an N-glycosylase capable of removing the following pyrimidine lesions to create AP sites: urea, 5, 6 dihydroxythymine, thymine glycol, 5-hydroxy-5 methylhydanton, uracil glycol, 6-hydroxy-5,6-dihdrothimine and methyltartronylurea. Endonuclease III combined with Endonuclease IV, Vent(exo-) polymerase and fluorescent nucleotides can label sites of oxidized pyrimidine damage as well as sites consisting of single strand breaks (SSBs) and apurinic/apyrimidic (AP) sites along the DNA backbone. By determining the fluorescent labels along the DNA backbone, the distribution and the density of oxidized pyrimidines can be established with great accuracy (FIG. 6b). Additionally, frank DSBs and DSBs due to clustered oxidized pyrimidine damage converted to SSBs can be measured by size distribution of molecule lengths (FIG. 6a).

Use of Alkaline Treatment of DNA Embedded Gel Plugs to Enhance Sensitivity to Damaged Bases, in the Form of Abasic Sites, which can then be Recognized and Labeled by Endonuclease IV and Vent Polymerase, and Detected in Nano-Channel Array.

In an alternative cell-based DNA damage assay (FIG. 7), alkaline solutions may be used to convert damage-induced abasic sites into single strand breaks (SSBs) without cooperation of enzymatic activity. SSBs derived from alkaline-converted abasic sites (as well as the majority of frank SSBs), however, may not be always extendable by polymerases. As set forth elsewhere herein, Endonuclease IV possesses 3′-phosphodiesterase activity, which activity in turn permits conversion of a significant proportion of non-extendable SSBs with 3′ blocking groups into polymerase-extendable nick sites that can be fluorescently labeled with fluorescent nucleotides during polymerase extension.

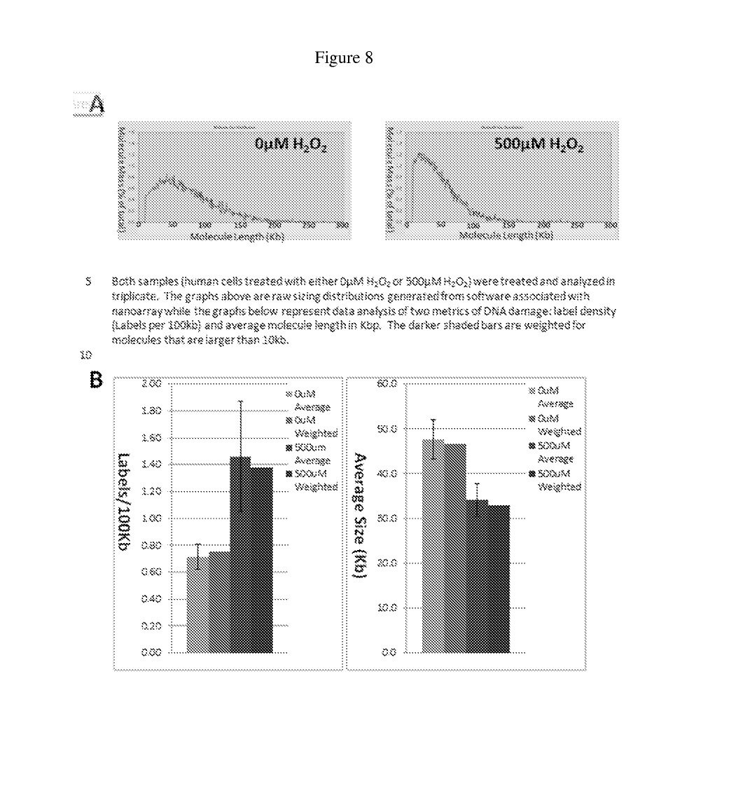

Alkaline treatment also has the effect of converting closely spaced SSBs into DSBs via local alkali-induced denaturation of the DNA backbone—leading to a more sensitive assay for detecting damage-induced double strand breaks (DSBs). Embedding cells in agarose to yield purified DNA eliminates shearing forces associated with direct handling of DNA, such as pipetting, that can lead to fragmentation, permitting improved detection of true damage-induced fragmentation. Additionally, the porous gel matrix allows buffer exchange in order to facilitate appropriate buffer conditions necessary for subsequent enzymatic reactions following alkaline treatment. In FIG. 8, a cell-based oxidative assay is demonstrated with hydrogen peroxide as the oxidative damage agent. The raw DNA size histograms (FIG. 8A) of treated vs. untreated cells, demonstrates a clear shift to smaller fragment sizes for DNA purified from hydrogen peroxide-treated cells compared to the untreated control. The average size of the DNA and the label incorporation density (FIG. 8B) after hydrogen peroxide treatment demonstrate clear oxidative damage detection in the form of DSBs and SSBs, respectively.

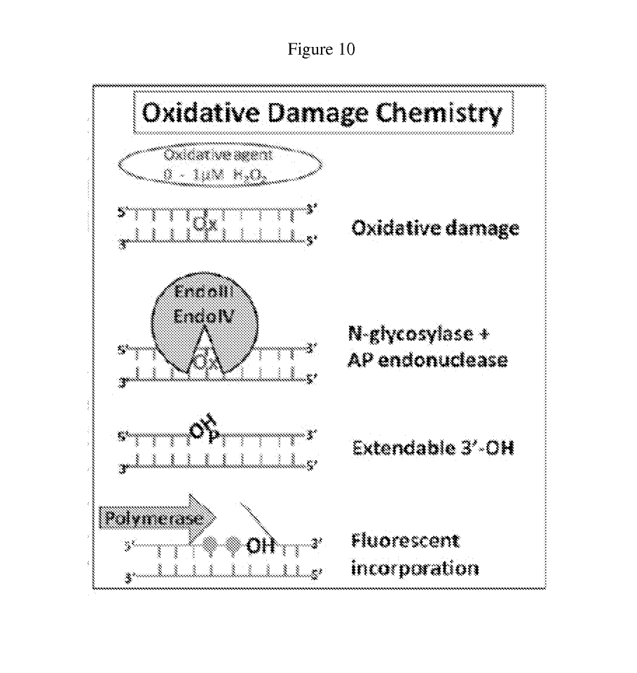

FIG. 10 illustrates an exemplary analysis pathway for assessing oxidative damage. In oxidative damage, the most significant consequence of the oxidative stress is thought to be the DNA modifications, which can cause mutations and genomic instability. Oxidation products formed in DNA include strand breaks, base-less sugars or AP (apuriniciapyrimidinic) sites, and oxidized bases. As shown in the figure, labels (e.g., fluorescent labels) may be incorporated at the site of the oxidative damage, which labels may be later imaged.

As shown, in one oxidative damage labeling chemistry, Endonuclease Ill is an N-glycosylase capable of converting oxidized pyrimidines into apyrimidic (AP) sites and non-extendable single strand breaks (SSBs). Endonuclease IV is in turn used to convert AP sites and non-extendable SSBs into single strand breaks containing a 3′-OH capable of polymerase extension. Fluorescently labeled nucleotides are then incorporated at the site of base damage by DNA polymerase and imaged within the nano-channel array in order to measure DNA damage by label density and molecule length distribution.

Additional Material

Further disclosure is found in the following patent application documents, each of which is incorporated herein by reference in its entirety for all purposes. Patent application PCT/US2007/016408, “Nanonozzle Device Arrays: Their Preparation And Use For Macromolecular Analysis,” filed Jul. 19, 2007; patent application PCT/US2008/058671, “Methods Of Macromolecular Analysis Using Nanochannel Arrays,” filed Mar. 28, 2008; patent application PCT/US2009/046427, “Integrated Nanofluidic Analysis Devices And Related Methods,” filed Jun. 5, 2009; patent application PCT/US2009/049244, “Methods And Devices For Single-Molecule Whole Genome Analysis,” filed Jun. 30, 2009; patent application PCT/US2009/064996, “Polynucleotide Mapping And Sequencing,” filed Nov. 19, 2009; patent application PCT/US2010/035253, “Devices And Methods For Dynamic Determination Of Sample Spatial Orientation And Dynamic Repositioning,” filed May 18, 2010; patent application PCT/US2010/050362, “Nanochannel Arrays And Near-Field Illumination Devices For Polymer Analysis And Related Methods,” filed Sep. 27, 2010; and patent application PCT/US2010/053513, “Methods And Related Devices For Single Molecule Whole Genome Analysis,” filed Oct. 21, 2010.

The disclosed assays can directly image the size distribution of the molecular population and nucleotide modifications of DNA molecules in nano-channel array. The assay may begin with enzymatic labeling of specific nucleotide modifications (single strand breaks or chemical modifications) on long genomic DNA molecules with fluorophores or other labels. The labeled DNA molecules are then linearized (e.g., inside a nanochannel array) and imaged with high resolution fluorescence microscopy. By localizing fluorescent labels on the DNA backbone, the structural information of the genome and the distribution of modified nucleotides on individual DNA molecule can be inferred with great accuracy. The miniaturized nanoarray device together with the flexible and efficient labeling chemistry enables direct imaging analysis of whole genome at single molecule level.

Certain DNA damage can block DNA polymerase progression, in turn affecting PCR efficiency. Specific DNA lesions also affect the fidelity of polymerase incorporation with misincorporation resulting in mutations. For example, in the presence of 8-oxo-7,8-dihydro-20-deoxyguanosine (8-oxodG), Taq DNA polymerase inserted dCMP and to a lesser extent dAMP. In another case, the presence of a single 8-oxo-7,8-dihydro-2-deoxyadenosine, abasic sites, or a cis-syn thymidine dimer dramatically reduced amplification efficiency.

Many sequencing technologies require the construction of sequencing library from genomic DNA, whose quality and genome representation determine the final sequencing results. The quality of the sequencing library is determined by the quality of genomic DNA and the library construction processes. The disclosed methods do not necessarily require PCR and, as described above, allow the user to assess the quality of a library.

1-92. (canceled)

93. An analysis system, comprising:
a sample stage configured to receive a fluidic chip, wherein the fluidic chip comprises one or more nanochannels having at least one dimension in a range of from about 1 nm to about 250 nm,
two or more illumination sources configured to illuminate a sample disposed within the fluidic chip, wherein each illumination source is configured to provide a different illumination wavelength; and
an image collector configured to collect one or more images of an illuminated sample disposed within the fluidic chip.

94. The system of claim 93, further comprising a detector capable of detecting positions of one or more beams of illumination reflected from the sample disposed within the fluidic chip.

95. The system of claim 93, further comprising a controller configured to translate the sample stage in response to a position of a beam of illumination reflected from the fluidic chip.

96. The system of claim 93, further comprising at least one filter capable of being disposed in an illumination path so as to provide a desired illumination wavelength to the sample disposed within the fluidic chip.

97. The system of claim 93, further comprising a beam expander disposed in an illumination path between the illumination source and the sample.

98. The system of claim 93, wherein the system comprises a source of electric field configured to move one or more macromolecules into nanochannels of the fluidic chip.

99. The system of claim 93, further comprising a reader configured to recognize the system in accordance with one or more indicia disposed on the fluidic chip.

100. The system of claim 93, wherein the system is configured to utilize wide-field illumination to achieve single molecule fluorescent detection in the nanochannel.

101. The system of claim 93, wherein the illumination source is selected from the group consisting of laser, light emitting diode, incandescent bulb, ultraviolet source, or any combinations thereof.

102. The system of claim 93, wherein the system includes an integrated autofocus unit configured to maintain automated optical focus of the sample.

103. The system of claim 102, wherein the integrated autofocus unit comprises at least one additional illumination source, wherein the additional illumination source shares an optical path of other illumination sources and is aligned to accommodate focus tracking of a nanostructured imaging surface.

104. The system of claim 93, wherein the system is partially or fully automated.

105. The system of claim 93, further comprising an evaporation control system for mitigating or controlling sample reservoir evaporation.

106. The system of claim 93, wherein the system is capable of determining one or more structural characteristics of a macromolecule.

107. The system of claim 93, wherein the system is capable of correlating the one or more structural characteristics of the macromolecule to a physiological characteristic of a patient.

108. The system according to claim 93 configured for analysis of DNA, RNA, proteins, biopolymers, biological macromolecules, non-biological macromolecules, or any combination thereof.

109. A method for analyzing a polynucleotide sample, comprising:
labeling multiple polynucleotides in the sample with at least two types of optically-detectable labels;
loading the labeled sample into a fluidic chip;
moving at least a portion of the labeled polynucleotides into a plurality of nanochannels in the fluidic chip and maintaining the labeled polynucleotides in the nanochannels in a linearized form;
illuminating the sample with a first light source and then imaging the labeled polynucleotides in the nanochannels;
illuminating the sample with a second light source and then imaging the labeled polynucleotides in the nanochannels; and
moving more labeled polynucleotides into the nanochannels and repeating the illuminating and imaging steps.

110. The method of claim 109, further comprising autofocusing on the sample disposed within the nanochannels by automatically finding a primary focus position and then tracking that focus position once found.

111. The method of claim 109, further comprising recording one or more images of the sample.

112. The method of claim 109, comprising labeling a backbone of the polynucleotides with a first label and labeling a plurality of sites of the polynucleotide with a second label in a site-specific manner.

113. The method of claim 109, further comprising characterizing at least one structure feature of the sample based on locations of the labels on the polynucleotides.

114. The method of claim 109, further comprising preventing or mitigating evaporation of the sample after loading.

115. The method of claim 109, further comprising using wide-field illumination for imaging the sample.

116. A method for assessing damage to a polynucleotide, comprising:
incorporating a label at or proximate to a site of damage on a polynucleotide due to ultraviolet radiation, ionizing radiation, or oxidation;
linearizing a region of the polynucleotide that includes the label; and
imaging the label.
